(19) United States
(12) Patent Application Publication
(10) Pub. No.: US 2008/0281671 A1
(43) Pub. Date: Nov. 13, 2008

(54) Method for determining a person's quality of life

(75) Inventor: Miranda Aref Farage, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company

(21) Appl. No.: 11/800,845

(22) Filed: May 8, 2007

(51) Int. Cl. G06F 17/30

(52) U.S. Cl. 705/10

(57) ABSTRACT

A method of validating a questionnaire for use in determining quality of life indicators for users of consumer products is disclosed. The method includes the steps of;
e. providing a plurality of consumers a consumer product for use;
f. using, by said consumers, said consumer product according to its intended use;
g. providing to said consumers a questionnaire comprising a plurality of questions;
h. answering, by said consumers, the questions on said questionnaire;
i. analyzing said answers for each said questionnaire;
j. interviewing at least some of said consumers individually with respect to their respective questionnaire to correlate said consumer's answers with said consumer's subjective feelings;
k. if said answers and said subjective feelings from step (f) do not correlate sufficiently to accurately characterize quality of life aspects, changing one or more questions on said questionnaire and repeating steps (c) through (f); and
l. if said answers and said subjective feelings from step (f) do correlate sufficiently to accurately characterize quality of life aspects of said consumer, consider questionnaire to be validated.

### FIELD OF THE INVENTION

This invention relates to the field of assessing the pre-use, during-use, and post-use characteristics of users of consumer products.

### BACKGROUND OF THE INVENTION

Consumer products are marketed to consumers, generally at retail outlets. Consumers purchase and use products based on real and perceived needs. The choices consumers make in deciding which of a range of similar products to purchase are often based on marketing claims made by the manufacturers of the products. Except for clear puffery and other exaggerations, advertising and marketing claims should be supported by quantitative measures. Quantitative measures can be in the form of data gathered in consumer product testing, and often shows comparative data to differentiate one product over another.

Consumer products can be marketed for a specific purpose without regard for secondary considerations. For example, disposable absorbent products can be marketed with the primary benefit of hygienically containing body wastes, without concern for secondary considerations such as comfort, ease of use, ease of disposal, and the like. But many consumer products, like disposable absorbent products, such as diapers, sanitary napkins, pantiliners, and the like, are marketed to consumers who make product selections based on more than just the primary capability of the product to perform its primary purpose. If manufacturers of consumer products can accurately predict what secondary considerations appeal to consumer, they can better market new products.

Beyond primary and secondary considerations in the marketing of consumer products, many manufactures of products also wish to improve the general quality of life of consumers of their products. Quality of life can be expressed as being a measure of the physique, mood, vitality, energy, well being, self confidence, or happiness of an individual, and can have spiritual, emotional, or physical aspects, as well as sexual intimacy, self-esteem, and belonging. To date quality of life has been investigated in the context of medicine and pharmaceuticals to indicate changes in disease states, disorders, and other physiological changes. Inquiries into quality of life can be made after a particular dose or regimen of medication or similar treatment, for example.

There remains a need, however, for a way to accurately determine the quality of life of a user of a consumer product.

In particular, there remains a need for a way to accurately determine the quality of life of an individual after using a non-medicinal consumer product.

Additionally, there remains a need for a method of supporting marketing claims with respect to qualify of life aspects of a consumer product.

### SUMMARY OF THE INVENTION

A method of validating a questionnaire for use in determining quality of life indicators for users of consumer products is disclosed. The method includes the steps of;
a. providing a plurality of consumers a consumer product for use;
b. using, by said consumers, said consumer product according to its intended use;
c. providing to said consumers a questionnaire comprising a plurality of questions;
d. answering, by said consumers, the questions on said questionnaire;
e. analyzing said answers for each said questionnaire;
f. interviewing at least some of said consumers individually with respect to their respective questionnaire to correlate said consumer's answers with said consumer's subjective feelings;
g. if said answers and said subjective feelings from step (f) do not correlate sufficiently to accurately characterize quality of life aspects, changing one or more questions on said questionnaire and repeating steps (c) through (f); and
h. if said answers and said subjective feelings from step (f) do correlate sufficiently to accurately characterize quality of life aspects of said consumer, consider questionnaire to be validated.

A method of determining the quality of life of a person after using a consumer product is also disclosed. The method includes the steps of:
a. Identifying a plurality of consumers;
b. Providing to said consumers a validated questionnaire with questions to measure subjective feelings;
c. Answering said questions by said consumers; and
d. Analyzing said answers to determine subjective feelings.

### DETAILED DESCRIPTION OF THE INVENTION

Consumer products are manufactured articles intended to be sold at retail stores to consumers, who then use such products for their intended use. Examples of consumer products include electronic products such as televisions and computers; automotive products such as after-market parts and accessories; car care products such as washes and waxes; home care products such as floor cleaners and air fresheners; oral care products such as toothpaste and mouthwash; laundry products such as detergents and fabric softeners; clothing, jewelry, and beauty care products such as hair care and body care creams, gels, and conditioners, and skin care products such as lotions and razors. One class of consumer products is disposable absorbent articles, which includes disposable diapers, training pants, incontinence pads and pants, sanitary napkins, tampons, pantiliners, bandages and pessaries. Most disposable absorbent articles are intended to be disposed of after a single use.

Many consumer products, such as beauty care products and disposable absorbent products are intended to improve the lives of their users. For example, disposable absorbent products such as sanitary napkins and pantiliners are intended to provide worry-free comfort and protection to their users. For such products the primary purpose can be to absorb and contain body exudates, and a secondary consideration can be comfort, ease of disposal, and the like.

Once primary and secondary needs are met, however, it remains that consumers desire to have other, more personal needs met. Much like Maslow's hierarchy of needs, once physiological and safety needs are met (the first two levels in Maslow's pyramid), consumers may want to have other needs met, such as what Maslow referred to as “esteem”, which can include self-esteem, self-confidence, achievement, respect of others, and respect by others. Other personal needs can include physique perception, mood, vitality, happiness, and other feelings that can have spiritual, emotional, or physical aspects.

The present invention is a method of measuring, analyzing, and validating quality of life indicators for consumer products. By the method of the present invention a validated questionnaire can be utilized to determine certain quality of life measures of users of consumer products. The method can be used to find ways to improve the quality of life of certain consumers. The method can also be used to quantify quality of life changes so as to enable accurate marketing claims for consumer products. Quality of life can be expressed as being a measure of the physique, mood, vitality, energy, well being, self confidence, or happiness of an individual, and can have spiritual, emotional, or physical aspects, as well as sexual intimacy, self-esteem, and belonging.

The method uses a validated questionnaire in which consumers answer questions after using a consumer product. The questions can measure both the consumer's knowledge of the use of the product, as well as the consumer's subjective feelings. The questionnaire is validated by a process of cognitive interviews with consumers. The cognitive interviews are made with consumers after they have used a product and answered questions about their experience in a written questionnaire. The interview process seeks to ensure that answers to questions accurately and sufficiently reflect the subjective feelings of the consumer. If the cognitive interview does not confirm that the questionnaire accurately reflects changes in subjective feelings of the consumer, the questions are adjusted and the process is repeated with the same or with different consumers. Adjusting questions can include deleting, adding, or changing questions.

Once the cognitive interviews indicate that the questions in the questionnaire accurately and sufficiently reflect the subjective feelings of the consumer, the questionnaire is considered to be validated. Statistical methods known in the art can be used to further specify multiple factors, such as primary and secondary factors affecting subjective feelings, and their respective weight with respect to predictive value of quality of life.

Once the questionnaire is validated, the questionnaire can be utilized with a plurality of consumers and a range of like products to measure quality of life. For example, a plurality of consumers can be provided a particular consumer product, such as a supply of sanitary napkins, for use over a period of time. After use, the consumers can answer the questions from the validated questionnaire. Based on the answers, the manufacturer of the consumer product can determine if desirable quality of life aspects are changed. In one aspect, the change in quality of life can be determined by providing the questionnaire over a longer period of time, with multiple questionnaires. Such quality of life valuations can be made for like products in the market and the results can be utilized to support marketing and advertising comparisons.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of validating a questionnaire for use in determining quality of life indicators for users of consumer products, the method comprising the steps of;
a. providing a plurality of consumers a consumer product for use;
b. using, by said consumers, said consumer product according to its intended use;
c. providing to said consumers a questionnaire comprising a plurality of questions;
d. answering, by said consumers, the questions on said questionnaire;
e. analyzing said answers for each said questionnaire;
f. interviewing at least some of said consumers individually with respect to their respective questionnaire to correlate said consumer's answers with said consumer's subjective feelings;
g. if said answers and said subjective feelings from step (f) do not correlate sufficiently to accurately characterize quality of life aspects, changing one or more questions on said questionnaire and repeating steps (c) through (f); and
h. if said answers and said subjective feelings from step (f) do correlate sufficiently to accurately characterize quality of life aspects of said consumer, consider questionnaire to be validated.

2. The method of claim 1, wherein said consumer product is a disposable consumer product selected from the group of consisting of, diapers, training pants, feminine hygiene articles, sanitary napkins, pantiliners, bandages, hair care and the like.

3. The method of claim 1, wherein said consumer product is selected from the group consisting of, electronic products such as televisions and computers; automotive products such as after-market parts and accessories; car care products such as washes and waxes; home care products such as floor cleaners and air fresheners; oral care products such as toothpaste and mouthwash; laundry products such as detergents and fabric softeners; clothing, jewelry, and beauty care products such as hair care and body care creams, gels, and conditioners, and skin care products such as lotions and razors.

4. A method of determining the quality of life of a person after using a consumer product, the method comprising the steps of:
a. Identifying a plurality of consumers;
b. Providing to said consumers a validated questionnaire with questions to measure subjective feelings;
c. Answering said questions by said consumers; and
d. Analyzing said answers to determine subjective feelings.

5. The method of claim 4, further comprising the step after step (d) of making claims, including comparative claims to communicate characteristics of users of said consumer product.

6. The method of claim 5, wherein said characteristics include relative measures of physique, mood, vitality, confidence, energy, and combinations thereof.

7. The method of claim 4, wherein said consumer product is a disposable consumer product selected from the group of consisting of, diapers, training pants, feminine hygiene articles, sanitary napkins, pantiliners, bandages, hair care and the like

8. The method of claim 1, wherein said consumer product is selected from the group consisting of, electronic products such as televisions and computers; automotive products such as after-market parts and accessories; car care products such as washes and waxes; home care products such as floor cleaners and air fresheners; oral care products such as toothpaste and mouthwash; laundry products such as detergents and fabric softeners; clothing, jewelry, and beauty care products such as hair care and body care creams, gels, and conditioners, and skin care products such as lotions and razors.
